(19) United States
(12) Patent Application Publication
(10) Pub. No.: US 2024/0013977 A1
(43) Pub. Date: Jan. 11, 2024

(54) Method for producing a component provided with at least one electrically conductive conductor body

(71) Applicant: Schlaeger Kunststofftechnik GmbH, Bayreuth (DE)

(72) Inventors: Anton FUCHS, Rückersdorf (DE); Markus KRELLNER, Bindlach (DE)

(21) Appl. No.: 18/255,605

(22) PCT Filed: Nov. 23, 2021
(86) PCT No.: PCT/EP2021/082614

§ 371 Date: Jun. 2, 2023

(30) Foreign Application Priority Data
Dec. 4, 2020 (DE) 10 2020 132 337.9

(51) Int. Cl. H01F 41/12; H01F 41/00; H01F 41/071

(52) U.S. Cl. CPC H01F 41/127; H01F 41/005; H01F 41/071; H01F 27/022

(57) ABSTRACT

Method for producing a component provided with at least one electrically conductive conductor body, wherein the conductor body is surrounded at least in portions, in particular largely, in an integrally bonded and/or interlocking fashion by an injection-molded body formed from an injection-molding material. The method includes receiving the conductor body at least in portions in or on a receiving region of a carrier body, the receiving region delimiting a receiving space. The method also includes encapsulating the carrier body, provided with the conductor body, at least in portions with the injection-molding material to form a component comprising at least the conductor body, the carrier body and the injection-molded body.

The invention relates to a method for producing a component provided with at least one electrically conductive conductor body, wherein the conductor body is surrounded at least in portions in an integrally bonded and/or interlocking fashion by an injection-molded body formed from an injection-molding material.

Corresponding methods for producing a component provided with at least one electrically conductive conductor body are known in principle from the prior art. Typically, such electrical components may comprise, for example, electric coils or the like, wherein a conductor body is encapsulated with an injection-molding material in the course of a plastics injection-molding method. Here, a difficulty may lie in allowing the electrically active element or the conductor body to have a defined shape in the final state of manufacture. In particular, a great deal of technical effort is usually required to ensure that the conductor body is encapsulated in a defined orientation and/or positioning.

The object of the invention is to specify a method which improves the producibility of components provided with electrical conductor bodies, in particular with regard to a simple and fast as well as cost-effective measure. The object can also be based on the use of materials for the component provided with a conductor body, in particular for the conductor body, which are as technically simple to produce as possible and are cost-effective and readily available.

The object is achieved by a method for producing a component provided with at least one electrically conductive conductor body according to claim 1. The claims dependent thereon relate to possible embodiments of the method. Furthermore, the object is achieved by a component, in particular by a component comprising an electric coil, according to claim 23, and by an apparatus for producing a component comprising a conductor body and a carrier body, according to claim 24.

The invention relates to a method for producing a component provided with at least one electrically conductive conductor body, wherein the conductor body is surrounded at least in portions, in particular largely, in an integrally bonded and/or interlocking fashion by an injection-molded body formed from an injection-molding material, wherein the following method steps are carried out: (a) receiving the conductor body at least in portions in or on a receiving region of a carrier body, which receiving region delimits a receiving space, and (b) encapsulating the carrier body, provided with the conductor body, at least in portions with the injection-molding material to form a component comprising at least the conductor body, the carrier body and the injection-molded body. The conductor body is received at least in portions, preferably largely, particularly preferably almost completely, in or on a receiving region of a carrier body, which receiving region delimits a receiving space. Received almost completely can be understood to mean, for example, that the conductor body is received fully or is received in such a way that at most 25%, preferably at most 10%, particularly preferably at most 5% of the volume of the conductor body is arranged outside a receiving space.

An electrically conductive conductor body can be, for example, a conductor body consisting at least in portions of metal, in particular of copper, which makes it possible to conduct an electric current through it. The component comprising the at least one electrical conductor can, for example, form a component which comprises an electrotechnical coil and which is designed to generate or detect a magnetic field. The conductor body can, for example, be a magnetic-field-generating means and/or a magnetic-field-receiving means, in particular a corresponding electrical conductor. Alternatively or additionally, the component comprising at least one conductor body can form an electrical component or form part of a device, such as a transformer, a relay, an electric motor or a loudspeaker.

The carrier body provided with the conductor body is encapsulated at least in portions, preferably largely, particularly preferably almost completely, with the injection-molding material to form a component comprising at least the conductor body, the carrier body and the injection-molded body. In other words, a carrier body provided with a conductor body can be inserted into an injection mold and then encapsulated with an injection-molding material, for example a plastics injection-molding material. This results in a component or at least a part of the component in which the carrier body and the conductor body are connected to one another in an integrally bonded fashion via the injection-molding material due to the at least partial encapsulation or due to the hardening injection-molding material.

For example, it can be provided that the injection-molding material can surround the conductor body at least in portions, preferably largely, particularly preferably almost completely (with the exception, for example, of connection or contact regions). For example, the conductor body is directly or indirectly surrounded to an extent of at least 90%, preferably at least 95%, particularly preferably at least 98%, by the encapsulated injection-molded body or the injection-molding material. Alternatively or additionally, the assembly formed from the carrier body and the conductor body received in the receiving space of the carrier body can be surrounded by the encapsulated injection-molded body to an extent of at least 90%, preferably at least 95%, particularly preferably at least 98%. An encapsulation can also comprise, for example, an overmolding, i.e. a non-gripping encapsulation.

The carrier body can, for example, have wall portions that form the receiving region delimiting the receiving space. The wall portions can, for example by their wall thickness and/or by the material or the substance and/or by the geometric shape (for example lattice structure) of the wall portions, influence or define an insulation spacing between adjacent conductor body portions received in respective receiving regions. In other words, for example the choice of the wall thickness of the wall portions of the carrier body can influence or determine the electrical breakdown or the electrical insulation effect between adjacent conductor body portions or between conductor body portions received in adjacent receiving space spaces of the carrier body. The carrier body can be understood, for example, as a spacer for the conductor body portions received in its receiving space, wherein the carrier body can perform its spacing function for the conductor bodies through its wall portions and, in particular, additionally through its keeping free of receiving voids for receiving injection-molding material. This means, for example, that the provision of receiving voids in the deformed state of the carrier body can favor or even enable the addition or filling with injection-molding material, so that in the encapsulated state the effective spacing between the conductor body portions is formed by the elements forming the carrier body itself and by the injection-molding material introduced into receiving free spaces.

The wall portion defining the receiving space can, for example, be formed at least in portions, in particular completely, as a lattice body and can initially ensure a spacing of the conductor body portions. During the encapsulation, injection-molding material can penetrate into the gaps of the lattice body created by the spacing and thus can form the wall portions as solid bodies in the final state of manufacture, which are formed from the lattice-shaped carrier body and the injection-molding material.

The receiving of the conductor body in the carrier body can comprise an at least partial, in particular complete, receiving of the conductor body in or on a receiving region. The receiving region can have an at least partially, in particular completely, convex or concave or flat shape. Thus, for example, receiving can also be understood as a “placing” or “insertion” of the conductor body onto or into a, in particular flat, portion of the carrier body. It is possible that the receiving region forms a receiving space which comprises a recess, wherein in this recess the conductor body can be received at least in portions, in particular completely, in an interior of the recess.

It is possible that, after and/or during the receiving of the conductor body in or on the carrier body, the geometric shape of the carrier body is modified at least in portions, wherein, with the modification of the geometric shape of the carrier body, the conductor body undergoes or is given, at least in portions, a change in shape that is similar or identical, in particular in comparison with the deformation of the carrier body. Through the change in shape, the carrier body and also the conductor body are transferred from a pre-configuration or pre-geometry to a target configuration or a target geometry. Here, it can be provided that means causing the modification of the geometric shape act at least in part by contact with the carrier body and that the geometric change in shape of the stranded wire body is effected by the contact of the carrier body with the stranded wire body attached or inserted in or on the carrier body. In other words, the stranded wire body is deformed indirectly via the forces deforming the carrier body and consequently via the deformation of the carrier body. A means that deforms the carrier body can, for example, have no contact with the stranded wire body.

After the conductor body has been received in or on the carrier body, for example, a modification of the geometric shape of the carrier body can preferably take place largely, particularly preferably almost completely, so that a predominant, in particular an almost complete, portion of the carrier body is subjected to a change in shape.

In other words, it can be provided that in the undeformed state the carrier body and the conductor body have a first geometric shape and after a deformation process the carrier body and the conductor body have a second geometric shape different from the first geometric shape.

A similar or identical deformation or change in shape of the conductor body in comparison to the carrier body means here, for example, a deformation with a deformation or change in shape deviating by at most 25%, preferably by at most 15%, particularly preferably by at most 5%. Alternatively or additionally, a similar deformation with respect to a rotational and/or translational deformation may comprise similarities (i.e. for example stretching, compression, bending or the like differing by at most 25%, preferably by at most 15%, particularly preferably by at most %).

In a preferred exemplary embodiment, the change in shape of the conductor body and/or the carrier body after arranging the conductor body in or on the receiving region of the carrier body can comprise a deformation such that the body volume formed by the conductor body and/or the carrier body becomes more compact. In other words, the deformation of the conductor body and/or of the carrier body can reduce the pack size or the circumscribed space. For example, the conductor body and/or the carrier body thus has a higher density in the deformed state than in the undeformed state. Making the conductor and/or carrier body more compact can, for example, reduce the body volume of a reference body (for example a rectangle or a cube or a cylinder) surrounding or circumscribing the conductor and/or carrier body by at least 10%, more preferably by at least 35%, more preferably by at least 50%, most preferably by at least 75%.

The deformation and, in particular, the compacting of the conductor body and/or of the carrier body can be advantageous in that the provision of the conductor body and/or of the carrier body in the stretched or less compact state can be carried out more easily than in the deformed and thus more compact state. It can be provided that a carrier body has a straight and/or strand-like shape at least in portions in the non-deformed state and assumes a shape deviating from the straight and/or strand-like shape before and/or after and/or during the fitting of the carrier body with the conductor body.

In particular, a targeted deformation of the conductor body can be simplified by the receiving of the latter in the carrier body and the then joint deformation of conductor body and carrier body, since the carrier body can be designed in such a way that it, with regard to the conductor body received by it, selectively deforms said conductor body.

Through the selective deformation of the conductor body and carrier body, it can be achieved that the space factor can be optimized or compressed in the sense of a geometric utilization of the installation space. Alternatively or additionally, by the deformation of the conductor body and carrier body, the space factor can be selectively influenced in terms of the efficiency of the conductor body for a desired electrical effect of the conductor body. For example, a higher effectiveness or a higher efficiency of the electrical and/or magnetic effectiveness of the conductor body can be achieved in a simple and cost-effective manner through a compression of the conductor body occurring during the course of the deformation of the conductor body.

It is possible that at least one portion of the conductor body and/or of the carrier body undergoes a linear and/or a rotational movement at least in portions during its deformation or during the geometric change in shape, in particular the conductor body and/or the carrier body is bent and/or compressed during the deformation.

The linear and/or rotational movement, which is carried out during the deformation or the geometric change in shape of the conductor body and/or of the carrier body, can comprise a compression of the conductor body and/or of the carrier body. In the present context, a compression means a reduction of a linear dimension of the conductor body and/or of the carrier body. Preferably, a compression of an assembly comprising a carrier body and a conductor body can be carried out as a, in particular linear, “pushing-together movement” along an axis, in particular an axis of symmetry, of an electric coil of a component comprising an electric coil in the final state of manufacture.

It is possible that the conductor body and/or the carrier body, in particular during and/or before their/its deformation, has at least in portions at least one spiral shape, in particular a spiral shape comprising at least a basic cone-like shape and/or basic cylinder-like shape and/or basic pyramid-like shape. For example, in a carrier body which is at least partially, in particular completely, linear or straight, the conductor body can be inserted or mounted in the receiving space of the carrier body and, in the inserted state of the conductor body in or on the carrier body, this assembly can undergo a deformation or a geometric change in shape. This change in shape can, for example, be carried out in such a way that this assembly (carrier body and conductor body) is transformed from a linear or straight basic shape into a spiral shape.

A basic cone-like or basic cylinder-like or basic pyramid-like spiral shape can, for example, be understood to mean a shape that at least substantially has the basic shape of a cone, a truncated cone, a cylinder (for example similar to a screw thread), a pyramid or a truncated pyramid. In this case, the basic shape forms the superordinate shape of the plurality of turns or windings of the coil.

The conductor body and/or the carrier body can have a spiral shape at least in portions, preferably largely, particularly preferably almost completely. In this case, the course of the windings or of a linearly formed conductor body can, at least in portions, preferably largely, particularly preferably completely, run in the manner of a strictly monotonic continuous function or reproduce a discontinuous non-monotonic function. Consequently, the spacing between individual windings and adjacent windings of the conductor body can be constant at least in portions or can be different at least in portions.

Preferably, during the deformation of the conductor body and/or the carrier body, the spiral shape is deformed, in particular compressed, along an axis of the spiral shape, particularly preferably along an axis of symmetry of the spiral shape. In other words, a spiral shape can, for example, be the shape of the conductor body and/or the carrier body in the manner of a line (for example winding wire of the conductor body) wound on a lateral surface of a cone, a truncated cone, a pyramid, a truncated pyramid or a cylinder. Here, the pitch of the line can be constant or different at least in portions, preferably largely, particularly preferably completely. In a preferred embodiment, the shape of the spiral can form the shape of a conical spiral.

In this context, a compression is understood to be a pushing together or pressing together of the carrier body and/or conductor body.

It may prove advantageous if the carrier body has one or two or a plurality of spiral basic shapes. In this case, it may be advantageous that the spiral basic shapes are formed in such a way that each region forming a spiral basic shape forms a winding plane in the deformed state or in the deformed compact state of the carrier body, in particular at right angles to a coil axis.

Provided that the coil-like shape of the carrier and/or conductor body forms a pyramid-like shape, the base of such a pyramid may form any regular or irregular n-gon (for example quadrilateral, pentagon, hexagon, heptagon, octagon, etc.).

A first portion of the conductor body and/or carrier body can, for example, have a first, spiral, in particular cone-like or pyramid-like, basic shape and a second portion of the conductor body and/or carrier body can have a second, spiral, in particular cone-like or pyramid-like, basic shape, wherein a tapering region of the first spiral basic shape faces towards or faces away from a tapering region of the second spiral basic shape. The two tapering regions of the two basic shapes can face towards or away from each other, so that in the transition region from the first to the second portion there is no jump in the, in particular linear, conductor body, for example a conductor wire, and consequently a continuous course or one with a low gradual degree of modification of the geometric course of the conductor body is made possible.

Alternatively, it can be provided that the two widening regions of the cone-like or pyramid-like basic shape of the first and second portions of the conductor body and/or of the carrier body face each other. This leads to a comparable effect.

It is possible that, after or during the receiving of the conductor body in or on a receiving region of the carrier body, in a first injection-molding process, a first injection-molded body is molded onto or overmolded on the conductor body and/or the carrier body at least in portions, in particular completely, and in a second injection-molding process carried out in time after the first injection-molding process, a second injection-molded body is molded onto or overmolded on the first injection-molded body and/or the conductor body and/or the carrier body at least in portions. The first injection-molding process can be carried out, for example, before the modification of the geometric shape or change in shape of the conductor body and/or carrier body is performed. In this case, the first injection-molding process can form a pre-encapsulation which, together with a post-encapsulation, forms the finished component or an intermediate component. The pre-encapsulation can serve here for example as a fixation of the conductor body in or on the carrier body. The pre-encapsulation can also comprise an element that can perform a function during the downstream post-encapsulation process. For example, this element can be used as a spacer and/or as a guide means and/or centering means during receiving of the assembly comprising the conductor body and the carrier body provided with the pre-encapsulation into the injection mold for carrying out the post-encapsulation. Such multiple encapsulation of the carrier and/or conductor body can improve the length of a creepage distance. In an optional development, it is possible to perform at least two injection-molding methods, i.e. the component can be produced by performing two, three or more injection-molding processes and correspondingly two, three or more injection-molded bodies formed thereon.

In an optional embodiment, it can be provided that, once the conductor body has been received and preferably after the modification of the geometric shape of the carrier body and thus also of the conductor body, the carrier body provided with the conductor body undergoes an at least region-based encapsulation, in particular an at least region-based pre-encapsulation. This pre-encapsulation can comprise an encapsulation by means of a plastics material, in particular by carrying out a plastics injection-molding method. The pre-encapsulation can be carried out, for example, in such a way that the carrier body is at least partially, in particular completely, fixed in its modified shape. Alternatively, the pre-encapsulation can be carried out with the carrier and/or conductor body in an undeformed state or in a state with an unmodified shape.

The carrier body provided with a pre-encapsulation and the conductor body may, for example, be inserted into a molding tool to produce a further encapsulation to form a further portion attached to or molded on the carrier body. The downstream encapsulation may, for example, at least partially surround the pre-encapsulation. For example, the further encapsulation (for example end encapsulation) forms a housing for the carrier body. Preferably, the further encapsulation (for example end encapsulation) completely surrounds the carrier body and/or the conductor body with respect to an environment, with the exception of exposed contacts. It is possible that the pre-encapsulation comprises defined holding means, by means of which the pre-encapsulated carrier body can be held and/or oriented in a defined manner in a mold used for the attachment or application of a further encapsulation, for example in order to form the cavity intended for the further encapsulation.

It is possible that, after or during the receiving of the conductor body in or on a receiving region of the carrier body, the carrier body provided with the conductor body is received at least in portions, in particular completely, in or on a receiving volume of a base body, wherein, during the encapsulation, in particular by means of the injection-molding material, the conductor body, the carrier body and the base body are connected to one another at least in portions in an integrally bonded and/or interlocking fashion. An integrally bonded connection can be made by direct contact of the injection-molding material with the conductor body, the carrier body and the base body, and in this case the injection-molding material can form an integrally bonded connection of the body and can thus also connect these to one another. In other words, the conductor body, the carrier body and the base body are overmolded or encapsulated with the injection-molding material, or with the plastics material, in an injection-molding method, in particular in a plastics injection-molding method, to form an injection-molded body, so that a component comprising the conductor body, the carrier body, the injection-molded body and the base body is produced.

The base body can be designed, for example, as a housing or a housing part, into which the carrier body provided with the conductor body, in particular in its deformed state, is inserted at least in portions, preferably largely, particularly preferably almost completely, and, in the state in which it is inserted at least in portions, the injection-molding material is applied or forms an encapsulation around it, so that an assembly is formed which is connected in an integrally bonded and/or interlocking fashion.

The receiving volume of the base body can, for example, be formed as a cavity which is defined, at least in portions, indirectly or directly by base body walls formed by the base body. In other words, base body walls, in particular formed in one piece with the base body, define a receiving volume. Preferably, the base body walls have been produced at least in portions, preferably completely, in the course of a manufacturing method of the base body, for example the base body is a plastics injection-molding component, wherein the base body walls are formed at least in portions, in particular completely, in the course of the plastics injection-molding method to form the base body.

It is possible that (a) in or on the carrier body and/or (b) in or on the receiving volume of the base body before or during the encapsulation there is arranged at least one contact means, which forms an electrically conductive connection to the conductor body. The contact means can, for example, be designed as a plug contact in order to electrically connect a plug to the conductor body via the contact means in the final state of manufacture of the component. Preferably, at least one contact means region of the contact means is exposed after the encapsulation and/or a region of at least one contact means protrudes from the main volume of extent of the component, in particular from the injection-molded body, after the encapsulation. Preferably, the contact means is surrounded circumferentially or transversely to a longitudinal extent in a contacting and ring-like manner by the injection-molding material or the injection-molded body. It is also possible for the contact means to form a frictionally engaged and/or interlocking and/or integrally bonded connection to the carrier body before the encapsulation and/or before the deformation of the carrier body. For example, the contact means can be pre-fixed to the carrier body before the encapsulation, and thus has a certain position and/or orientation fixation for the encapsulation. The (final) fixing of the contact means for the intended use of the component can preferably take place in the course of the encapsulation and thus through the injection-molded body.

In a preferred embodiment, it can be provided that (a) in or on the carrier body and/or (b) in or on the receiving volume of the base body, at least one iron core and/or electrical component and/or magnetic-field-conducting element is arranged before or during the encapsulation and is encapsulated with the injection-molding material at least in portions during the encapsulation. The iron core may, for example, be formed at least in portions from ferrite. The electrical component may be, for example, a battery and/or a circuit board and/or an integrated electrical circuit and/or an element operating on the principle of RFID (radio-frequency identification). A magnetic-field-conducting element can, for example, have a magnetic-field-steering and/or -guiding and/or -strengthening property.

The iron core and/or the electrical component and/or the magnetic-field-conducting element can be arranged in or on the carrier body and/or in or on the receiving volume of the base body before the encapsulation, in particular before the deformation of the carrier body, and can preferably be connected (for example in the sense of a pre-fixation) in an integrally bonded and/or interlocking and/or frictionally engaged fashion in or on the carrier body and/or on the receiving volume of the base body. Alternatively or additionally, the iron core and/or the electrical component and/or the magnetic-field-conducting element can be arranged in or on the carrier body before the deformation of the carrier body, in particular can be fixed in or on the carrier in the sense of a pre-fixation.

It is possible that a conductor body is used which is designed as a stranded wire body and is formed at least from a group of electrically conductive individual wires, preferably the stranded wire body has at least in portions, in particular completely, at least one group of electrically conductive individual wires which are designed as high-frequency stranded wires and/or high-voltage stranded wires and/or as individual wires insulated from one another by an insulating layer, in particular an insulating layer having a lacquer layer and/or a silk. Typically, in the case of high-frequency stranded wires, the individual wires are insulated from one another by a lacquer layer, although they carry the same potential. In this way, the influence of a skin effect can be reduced or avoided at high frequency, since otherwise only a small part of the total cross-section would effectively “participate” in the transport of current. The individual wires of the stranded wire body can, for example, consist at least largely of copper. The individual wires of the stranded wire body can, for example, comprise a plurality of individual wires and optionally can be enclosed by a common insulating means, for example an insulating sheath. Such groups of individual wires enclosed by a common insulating material can be referred to as a stranded wire line, and several such stranded wire lines combined in a common cable can be referred to as cores.

The insulating layer and/or the insulating means can, for example, comprise a wrapping and/or a coating of at least some, in particular all, of the individual wires of the stranded wire body. For example, the insulating layer and/or the insulating means can be made of plastic or of a fibrous material, preferably of a vegetable or animal fibrous material, particularly preferably of silk.

Since, in the case of a conductor body having an insulating layer and/or an insulating means, in particular a conductor body in the form of a stranded wire body with an insulating layer between the individual wires, the insulating layer and/or the insulating means also experiences mechanical stress (for example due to bending) in the course of the deformation during the deformation of the carrier body and the conductor body, the mechanical loading of the insulating layer and/or of the insulating means can be relieved by the carrier body, since the carrier body can perform a guiding function for and/or a gentler deformation, i.e. deformation, for example exerting low compressive and/or tensile forces per surface portion on the insulating layer and/or the insulating means. In other words, the carrier body can selectively influence the forces acting on the insulating layer and/or on the insulating medium during the deformation of the latter and can thus reduce the demands on the insulating layer.

Furthermore, a basic insulation between the conductor body portions can be achieved by the carrier body walls causing a spacing between portions of the conductor body, so that the degree of the insulating effect of an insulating means and/or an insulating layer of the conductor body can be reduced. This may make it possible to avoid using, for example, technical grade silk as an insulating material or insulating material component for the insulating means and/or for the insulating layer, so that a more cost-effective component can be obtained. It may also prove advantageous if the carrier body and/or the injection-molded body enable a spacing function between conductor body portions, so that conductor bodies can be used which have no or a weaker insulating layer and/or insulating means, since this insulating layer or insulating means function can be provided at least in part by the carrier body and/or the injection-molded body.

It is possible that the carrier body and/or the base body is or was produced at least in portions, in particular completely, from an injection-molding method, in particular a plastics injection-molding method, and/or from an additive manufacturing method, also referred to as 3D printing.

It can be provided, for example, that a counter holder is used, which, during the deformation and/or during the encapsulation, rests at least in portions, preferably largely, against a surface region of the carrier body pointing radially inwards towards the center of the carrier body in the deformed state or in the target geometry state. Due to the contact of the counter holder with the surface region of the carrier body, its targeted deformation can be achieved and/or supported during the deformation process. In other words, a reproducible and/or targeted deformation of the carrier body and, if applicable, of the conductor body received in or on the carrier body can be made possible by the use of the counter holder, wherein the counter holder counteracts a deformation force acting on the carrier body as a stop or as a counter bearing, at least in portions, and thus enables a targeted deformation of the carrier body. For example, a counter holder can be used to ensure that a carrier body which is present in the undeformed initial state is bent around the counter holder at least in portions, in particular completely, in a straight and/or stretched manner, in particular wound around the counter holder more than once. The carrier body can be encapsulated before or during or after a removal or a withdrawal of the counter holder from the carrier body. As a result of this application of the counter holder to the at least partially, in particular completely, straight carrier body, the deformation thereof into a coil former can be carried out, for example.

It is possible for the carrier body and/or the base body to be made at least in portions, in particular completely, of a plastics material, preferably of a thermoplastic. For example, the following plastics materials can be used: polyamide (PA) and/or polyphenylene sulphide (PPS) and/or polybutylene terephthalate (PBT) and/or polybutylene terephthalate (PBT) with a glass fiber content of at most 15 vol. %, in particular at most 5 vol. %. It is advantageous if, in particular, the plastics material used for the carrier body has a moldability and/or hardness and/or elasticity and/or breaking strength which allows the predefined modification of the geometric shape to be carried out without material failure or without cracking.

In principle, an injection-molding material can be a thermoplastic or a thermoset. In all cases, the term “plastics material” can also include mixtures of different plastic materials and/or mixtures of plastics materials with other materials, such as additives, fillers, etc. Examples of thermoplastics have been given further above. Examples of thermosets are epoxy resins, polyurethane resins, polyester resins, phenolic resins. Thermosets can therefore be based in particular on epoxides, polyesters, polyurethanes or phenols.

It is possible that the carrier body comprises at least two carrier sub-bodies, wherein the carrier sub-bodies are assembled before and/or during the receiving of the conductor body in or on the receiving region of the carrier body. Thus, the carrier body can be designed as a built body, wherein at least two carrier sub-bodies are connected to each other in a frictionally engaged and/or integrally bonded and/or interlocking fashion. The frictionally engaged and/or integrally bonded and/or interlocking connection of the carrier sub-bodies to form the carrier sub-body can take place before and/or during the encapsulation of the carrier body. In an exemplary embodiment, the receiving region or receiving space for receiving the conductor body is formed only by assembling or joining together the carrier sub-bodies, so that the conductor body is received only after the carrier sub-bodies have been assembled. In other words, it may prove advantageous if a carrier body is used which comprises at least two carrier sub-bodies, wherein at least two carrier sub-bodies each comprise a receiving sub-region for at least partially forming the receiving region or the receiving space, wherein, in particular at least in the state of the encapsulated component and thus after the encapsulation of the carrier body and conductor body, the at least one conductor body is received or arranged in the at least two receiving sub-regions.

Furthermore, a carrier body of which the receiving region has an L-shaped and/or a U-shaped and/or a V-shaped and/or a C-shaped and/or a W-shaped cross-sectional geometry at least in portions can optionally be used. At least one conductor body can be received or arranged in the interior spaces of the L-, U-, V-, C- and/or W-shape.

Said shapes, in particular the C-shape, can be claw-shaped at least in portions, in particular completely, and at least in portions, in particular completely, grasp around the conductor body received in the receiving space thereof. The carrier body can have a constant cross-sectional geometry at least in portions, preferably largely, particularly preferably completely. The L-shaped and/or U-shaped and/or V-shaped and/or C-shaped and/or W-shaped cross-sectional geometry of the receiving region of the carrier body can, for example, be defined or formed by wall portions of the carrier body.

It is possible that a carrier body is used, the receiving region or receiving space of which has a first axial length in a first receiving region portion and a second axial length, different from the first axial length, in a further receiving region portion, preferably a first receiving region portion located closer to the center of the component has a greater axial length than a further receiving region portion located further away from the center of the component. An axial length of the receiving region portion means the length of a receiving region portion parallel to or along a longitudinal axis and/or axis of symmetry of the component. In particular, the axial length of the receiving region portion runs parallel to or along the axis of symmetry of a coil-like portion of the conductor body of the component. Preferably, the center of the component can form its axis of symmetry, in particular the axis of symmetry of a coil-like conductor body of the component.

For example, by making the axial length of the receiving region portion greater at a central point of the component than at a region further away from the center, it can be achieved that, while the cross-sectional area of the conductor body remains the same, the latter has a first cross-sectional shape (for example rectangular or oval with a different length to width) in a first receiving sub-region and a second cross-sectional shape (for example square or round), which differs from the first cross-sectional shape, in a further receiving sub-region.

In a further optional embodiment, a carrier body can be used which comprises, at least in portions, a guide device on a surface of at least one wall portion facing away from the receiving region of this carrier body, wherein the guide device carries out a targeted guidance of injection-molding material introduced or injected onto the carrier body during the encapsulation. Preferably, at least one guide device on the carrier body side is adapted to the geometric shape of a base body and/or the position and/or orientation of at least one injection opening of an injection mold for encapsulation of carrier and conductor bodies received therein, in order to achieve a defined or selective encapsulation of the carrier and conductor body. Preferably, the guide device also achieves, at least in portions, a selective encapsulation of the base body or of carrier and conductor bodies placed in or on a base body. It can also be optionally provided that the guide device guides injection-molding material to voids between carrier body sub-portions and/or conductor body sub-portions, where possible largely, in particular where possible completely, in order to backfill or provide a surrounding encapsulation using this injection-molding material. Alternatively or additionally, the guide device can have a spacing function so that, in the deformed state of the carrier body, carrier body sub-regions are kept at a defined spacing from one another by the guide device in order to provide or create any voids for the passage and/or filling of injection-molding material.

It is possible that at least one conductor body received in the receiving region of the carrier body, at least in the state before the carrier body provided with the conductor body is encapsulated with the injection-molding material, is held or connected in the receiving region by means of a holding means, in particular on the carrier body side, in an interlocking and/or integrally bonded and/or frictionally engaged fashion. The holding means on the carrier body side can, for example, be formed in one piece, i.e. with the same material, with the carrier body. For example, the holding means can be designed as a clamping element, in particular on the carrier body side, and can act in a clamping manner on a conductor body placed in or on a receiving region or in or on a receiving space of the carrier body. In other words, at least one holding means can be used to pre-fix a conductor body placed in or on the conductor body, wherein a final fixation is provided in the course of the encapsulation and thus by means of the injection-molding material.

It is possible that, while the conductor body is being received in or on the receiving region of the carrier body, the conductor body is guided at least in portions, in particular completely, in or on the receiving region by means of a guide means, in particular on the carrier body side. For example, the guide means can be designed as a sliding or guiding bevel, which supports the insertion or reaching of a desired position of the conductor body within the receiving space or the receiving region of the carrier body. The guide means can also serve as an end stop, for example, in order to support the reaching of a desired position of the conductor body. It is possible that an element of the carrier body fulfils the function of the guide means and the function of the holding means, i.e. enables both a guiding of the conductor body at least in portions on its way into the receiving space of the carrier body and also the holding of the carrier body in the receiving space.

During the modification of the geometric shape of the conductor body and/or of the carrier body, for example (a) an at least partial, in particular complete, guidance of a relative movement of at least two carrier body sub-regions by means of a guide portion, in particular on the carrier body side, and/or (b) an interlocking and/or a frictionally engaged and/or integrally bonded connection of at least two connection portions, in particular on the carrier body side, can take place. The guidance of the relative movement of the at least two carrier body sub-regions by means of the guide portion can be effective at least in portions, preferably largely, particularly preferably completely, over the path to be covered by the relative movement of the at least two carrier body sub-regions. The guide portion can be present, for example, as a portion of the carrier body which is effective in the sense of a guide and which interacts, at least in portions, with a counter guide portion during a deformation process of the carrier body in such a way that an at least partially defined relative movement of two sub-body sub-regions of the carrier body is achieved.

An interlocking and/or frictionally engaged and/or integrally bonded connection, at least in portions, of at least two connection portions on the carrier body side can be established, for example by connection elements arranged or formed on the carrier body side. For example, at least one engagement element, for example on a first carrier sub-body, and a counter element, for example on a further carrier sub-body, are provided on the carrier body and are designed in such a way that a frictionally engaged and/or interlocking connection can be achieved. Specifically, the frictionally engaged and/or interlocking connection can be designed as a snap-lock connection or as a clamping connection. For this purpose, a snap-in hook can be provided on a first fastening portion of the carrier body and a fastening portion as a snap-in hook receptacle, for example, can be provided on a further region of the carrier body. The connection portion can preferably be designed in such a way that it holds or fixes the carrier body in the deformed state of the carrier body, in particular which is a more compact state than in the initial state. In other words, the deformed, in particular compressed, carrier body can be prevented by the connection portion from springing back. As a result, the deformed carrier body remains reliably in its desired state, in particular in a more compact state, possibly under pretension, and can be supplied in this state to a casting process or encapsulation process. For example, the carrier body and conductor body in the compact state are inserted into an injection mold, preferably together with a base body, and are encapsulated by injection-molding material.

It is possible that at least one connection portion is formed on a contact means. Thus, it is possible that the contact means is attached to the carrier body before the carrier body is deformed and the connection portion function is or can be achieved, at least in portions, by (a) the contact of two such contact means or (b) the contact of a contact means with a counter region of a carrier body portion. In this case, the two connection partners can cooperate in such a way that an interlocking and/or frictionally engaged connection or holding of the carrier body is made possible. This means that a springing back of the deformed carrier body can consequently be prevented, wherein the connection portion function cannot be formed or provided on the carrier body itself, but at least partially on the contact means.

In a further advantageous embodiment, it may be provided that a carrier body is used which has at least two mutually corresponding guide portions and/or at least two mutually corresponding connection portions arranged or formed on different wall portions on the carrier body side. For example, the corresponding guide portions and/or connection portions are arranged or formed in such a way that they (a) have an identical or similar (for example at most 10%, preferably at most 5% difference) radial spacing from a center of the carrier body and/or of the component (b) lying on a common plane running perpendicular to the axis of the component 1.

Corresponding guide and/or connection portions means here that these corresponding portions interact with each other in such a way that a guiding or connecting function is or can be performed.

It is also possible that a first conductor body is received in a receiving region delimiting a first receiving space and that a further conductor body is received in a receiving region delimiting a further receiving space, in particular before at least one carrier body provided with the conductor body is encapsulated with an injection-molding material. Preferably, both conductor bodies or the conductor bodies located in the different receiving spaces are enclosed or encapsulated with injection-molding material at least in portions in a common encapsulation process step. The at least two receiving spaces can be separated from each other in such a way that the conductor bodies arranged in the respective receiving spaces cannot touch each other.

It is possible that the component comprises at least two conductor bodies which run in a helical or coil-like manner and are separated from one another, in particular electrically, by a wall portion of the carrier body and/or by injection-molding material in the final state of manufacture of the component or in the state in which the component is in its intended form. It is possible that at least partially, in particular completely, separate receiving spaces are provided on the carrier body side for receiving different conductor bodies. In this case, a multi-part carrier body can be provided to form the different receiving spaces. The at least two conductor bodies can, for example, be formed from different materials and/or substances and/or from a different number of individual wires or can have a different cross-section.

In addition to the method for producing a component provided with at least one electrically conductive conductor body, the invention also relates to a component, in particular an electric coil, comprising a conductor body and a carrier body, produced in a method described herein. The component can be installed in a vehicle, in particular in a motor vehicle.

The invention also relates to a device for producing a component comprising a conductor body and a carrier body according to a method described herein. This device can comprise, for example, a counter holder, which acts as a deforming element during the deformation of the carrier body provided with the conductor body.

All advantages, details, embodiments and/or features of the method according to the invention are transferable or applicable to the component according to the invention and to the device according to the invention for producing a component comprising a conductor body and a carrier body.

The invention is explained in greater detail by means of exemplary embodiments in the drawings. In the drawings:

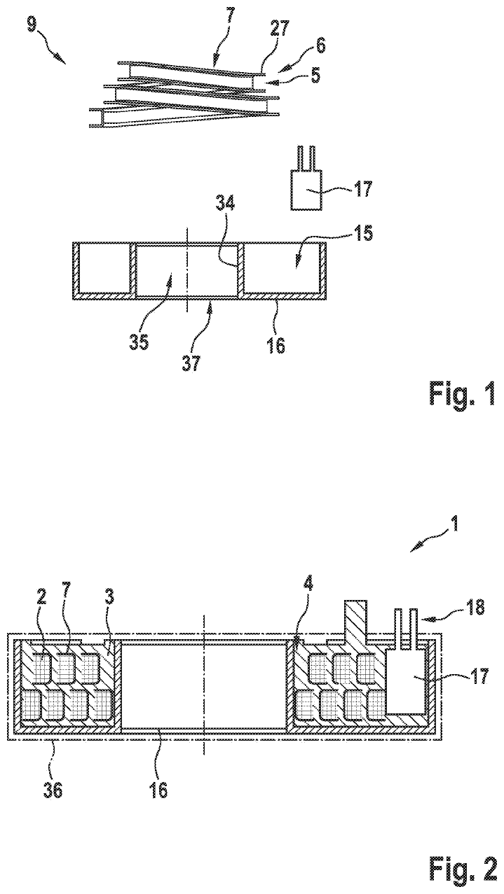

FIG. 1 shows a schematic exploded view of a component according to an exemplary embodiment;

FIG. 2 shows a schematic depiction of a component in the final state of manufacture according to an exemplary embodiment;

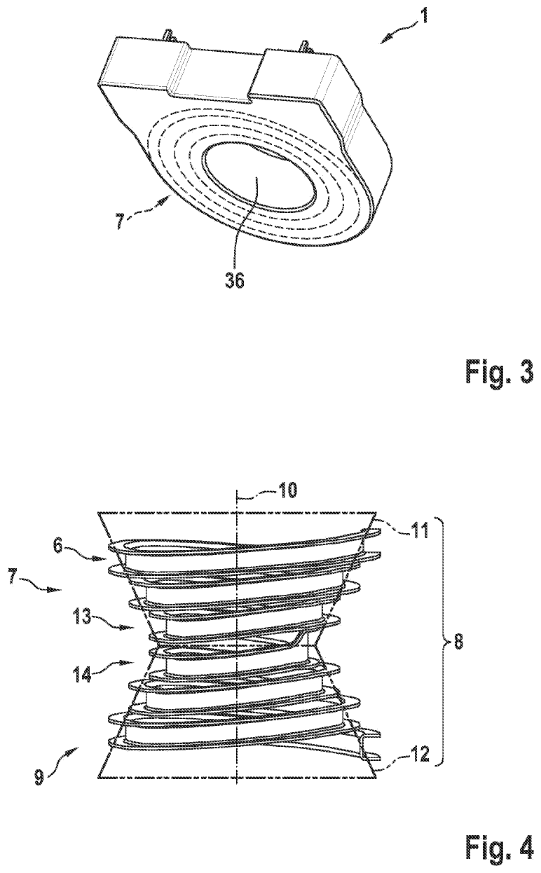

FIG. 3 shows a perspective semi-transparent principle depiction of a component in the final state of manufacture according to an exemplary embodiment;

FIG. 4 shows a perspective view of a carrier body in an undeformed state according to an exemplary embodiment;

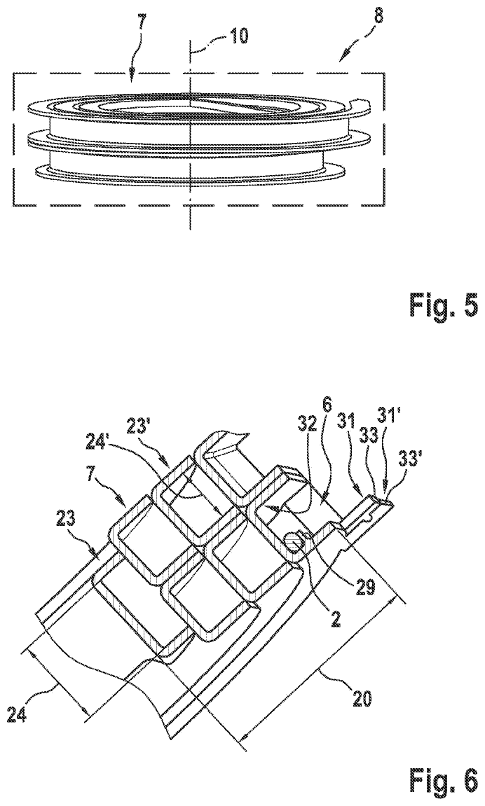

FIG. 5 shows a perspective view of a carrier body in a deformed state according to an exemplary embodiment;

FIG. 6 shows a schematic sectional view of the carrier body in a deformed state according to an exemplary embodiment;

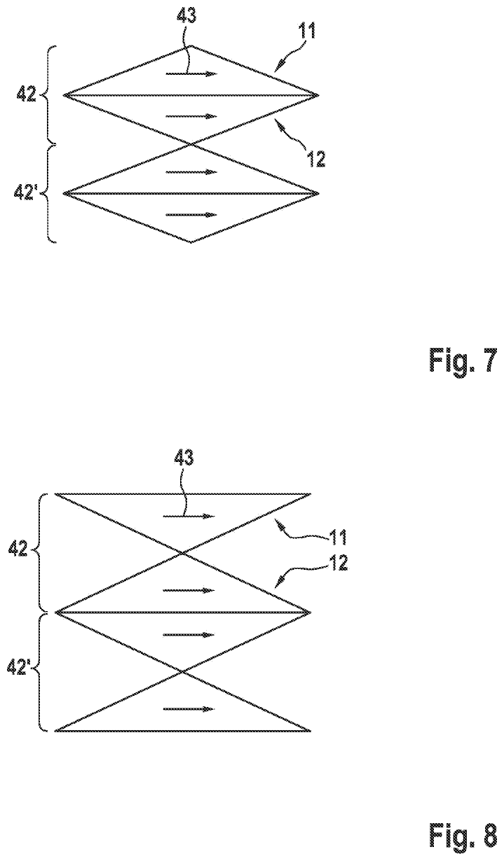

FIG. 7 shows a principle depiction of a carrier body in an undeformed state according to an exemplary embodiment;

FIG. 8 shows a principle depiction of a carrier body in an undeformed state according to an exemplary embodiment;

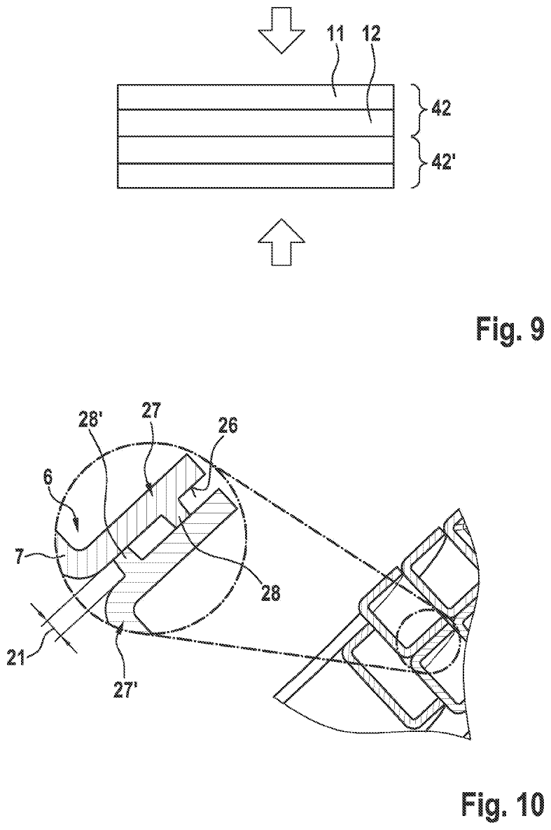

FIG. 9 shows a principle depiction of a carrier body according to FIG. 6 or 7 in a deformed state;

FIG. 10 shows a schematic detailed view of a close-up region of two adjacent carrier body portions according to an exemplary embodiment;

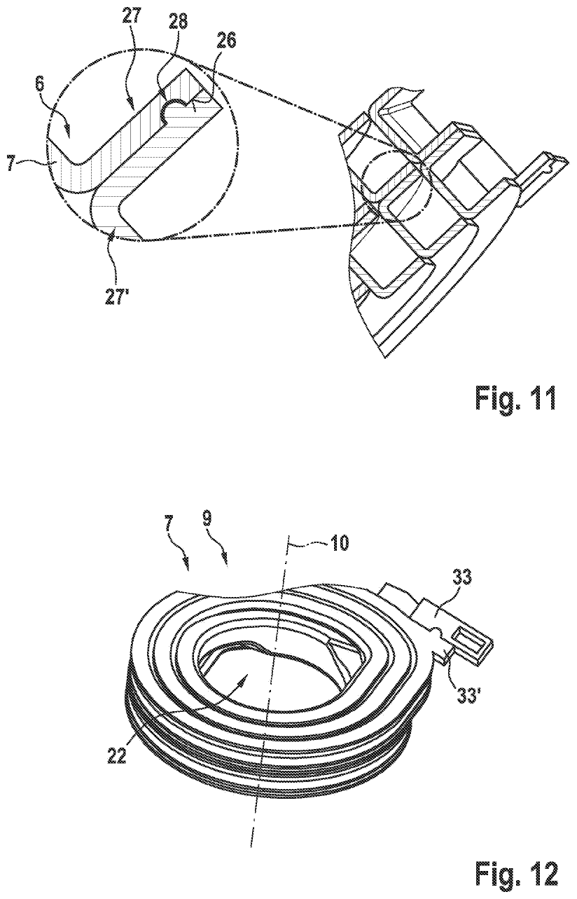

FIG. 11 shows a schematic detailed view of a close-up region of two adjacent sub-body portions according to an exemplary embodiment;

FIG. 12 shows a perspective principle depiction of a carrier body in a deformed state according to an exemplary embodiment; and

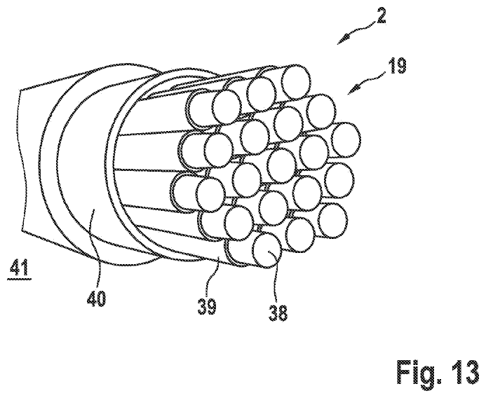

FIG. 13 shows a perspective principle view of a conductor body formed as a stranded wire body.

A method for producing a component 1 provided with at least one electrically conductive conductor body 2 is explained below. The conductor body 2 of the manufactured product, i.e. of the component 1 in the finished state, is surrounded here at least in portions, in particular largely, in an integrally bonded and/or interlocking fashion by an injection-molded body 4 formed from an injection-molding material 3. As can be seen in FIG. 2, an injection-molding material is arranged or formed or molded between and/or around a group of component parts, namely between and/or around a conductor body 2, a carrier body 7 and a base body 16.

The method provides for the method steps that the conductor body 2 is received at least in portions in or on a receiving region 6 of a carrier body 7, which receiving region delimits a receiving space 5, cf. FIG. 1, which shows a carrier body 7 which has a U-shaped receiving space 5 defined by wall portions 27 on the carrier body side. The conductor body 2 is inserted into this U-shaped receiving space 5. In a subsequent method step, the carrier body 7, provided with the conductor body 2, is encapsulated at least in portions with the injection-molding material 3 to form a component 1 comprising at least the conductor body 2, the carrier body 7 and the injection-molded body 4. FIG. 1 shows an exploded view of the conductor body 2, the carrier body 7, the base body 16 and a contact means 17. The conductor body 2, the carrier body 7 and the contact means 17 can be fitted or inserted in a receiving volume 15 of the base body 16 and lastly encapsulated at least in portions by an injection-molding material 3, so that the component 1 is present in its final state of manufacture, cf. FIGS. 2 and 3.

After and/or during the receiving of the conductor body 2 in or at the carrier body 7, the geometric shape of the carrier body 7 can optionally be modified at least in portions, wherein, with the modification of the geometric shape of the carrier body 7, the conductor body 2 undergoes or is given, at least in portions, a change in shape that is similar or identical, in particular in comparison with the deformation of the carrier body 7. An exemplary change in shape of the carrier body 7 can be seen from the comparison of FIG. 4 (undeformed state) and FIG. 5 (deformed state). If the conductor body 2 is inserted or placed in the receiving region 6 of the carrier body 7 before the deformation of the carrier body 7, the conductor body 2 also undergoes a change in shape at the same time as the change in shape of the carrier body 7 or with a slight time delay. It is possible that the change in shape of the conductor body 2 and/or the carrier body 7 after arranging the conductor body 2 in or on the receiving region 6 of the carrier body 7 comprises a deformation such that a body volume 8 formed by the conductor body 2 and/or the carrier body 7 becomes more compact.

The body volume 8 of the conductor body 2 and of the carrier body 7 can be understood as a reference volume or standard volume (for example, by circumscribing these bodies 2, 7 by a rectangle or cylinder or cube) of these two bodies 2 and 7 to indicate the compactness of the bodies 2, 7. In FIG. 4, the two basic shapes 11, 12 indicate approximately the body volume 8; in FIG. 5, the body volume 8 is indicated by a dashed line. In other words, in the undeformed state the carrier body 7 and/or the conductor body 2 is present in a state comprising a larger filling dimension than in the deformed state. The deformed state can, for example, correspond to the final state of manufacture of at least the carrier body 7 and/or the conductor body 2, so that in the deformed state of the two bodies 2, 7 an encapsulation and thus their integrally bonded connection allows this target state or this target geometry to be fixed.

At least one portion of the conductor body 2 and/or the carrier body 7, during deformation thereof, can perform or undergo a linear and/or a rotational movement. In particular, the conductor body 2 and/or the carrier body 7 is bent at least in portions, in particular completely, during the deformation.

In a method step preceding the deformation of the carrier body 7, it can be provided that during the insertion or receiving of the conductor body 2 in or on the receiving region 6 of the carrier body 2, the conductor body 2 undergoes a selective change in shape. For example, a conductor body 2 can undergo an elastic and/or plastic change in shape or deformation during its insertion into the receiving region 6 due to the counter force acting on the conductor body 2 by means of the carrier body 7. In this case, the conductor body 2 can preferably follow the shape predefined by the, in particular more rigid, carrier body 7 or its receiving region surface. In other words, by receiving the conductor body 2 in or on the carrier body 7, the carrier body 7 can have a shaping effect on the conductor body 2. In this way, it is possible, for example, to achieve also more complex or technically difficult modifications to the shape of the conductor body 2 in a simple and cost-effective manner by means of a selective embodiment of the carrier body 7 and its shaping effect during the receiving of the conductor body 2.

The conductor body 2 and/or the carrier body 7 may, in particular before its deformation, have at least in portions, preferably largely, particularly preferably completely, at least one spiral shape 9, in particular a spiral shape 9 comprising at least a basic cone-like shape and/or a basic cylinder-like shape and/or a basic pyramid-like shape. It is possible that, during the deformation of the conductor body 2 and/or the carrier body 7, the spiral shape 9 is compressed along an axis 10 of the spiral shape 9, particularly preferably along an axis of symmetry of the spiral shape 9, or is subjected to compressive forces pointing towards the center of the spiral shape 9. As shown for example in FIG. 4, the carrier body 7 (and/or the conductor body 2) may have a curved line-like shape, wherein this line-like shape extends in the manner of at least one spiral within the space.

In other words, the carrier body 7 provided with the conductor body 2 can be compressed in such a way that parts of the carrier body 7 are sunk into spaces predefined by the shape of the carrier body 7, cf. FIGS. 4 and 5.

It is possible that a first portion of the conductor body 2 and/or carrier body 7 has a first, spiral, in particular cone-like or pyramid-like, basic shape 11 and a second portion of the conductor body 2 and/or carrier body 7 has a second, spiral, in particular cone-like or pyramid-like, basic shape 12, wherein a tapering region 13 of the first spiral basic shape 11 faces towards or faces away from a tapering region 14 of the second spiral basic shape 12. A spiral basic shape 11, 12 can be understood to mean, for example, a course of at least a portion, in particular a complete course, of a carrier body 7 and/or of a conductor body 2, according to which a portion of the carrier body 7 and/or of the conductor body 2 runs lying at least substantially in or on a basic shape surface of a basic shape 11, 12. For example, as shown in FIG. 4, the line-like course of the carrier body 7 can extend running substantially on a surface of a pyramid. In the example shown in FIG. 4, the line-like carrier body 7 runs along ends of two pyramid-shaped or pyramid-like basic shapes 11, 12, the tips or tapering regions of said ends facing each other. The basic shapes 11, 12 have been schematically visualized in FIG. 4 by dash-and-double-dot lines.

In FIGS. 7 and 8, further or alternative configurations of the carrier body 7 are shown in abstract form, in which case the carrier body 7 and/or the carrier body 7 provided with a conductor body 2 may have spiral shapes tapering in pairs in portions. In FIG. 7, four, for example conical, basic shapes 11, 12 are shown, wherein the upper and the lower pair 42, 42′ of the basic shapes 11, 12 in each case face each other with their widened end region. In the deformed or compressed state (see FIG. 9), the carrier body portions are nested in one another or moved into each other, at least in portions. In FIG. 8, the pairs of basic shapes 42, 42′ in each case face each other with their tapered end regions, wherein the deformed state of this embodiment can also be seen in FIG. 9. The arrows 43 shown in FIG. 8 indicate the winding direction of the conductor body 2 within the basic shape 11, 12, wherein it can be seen that the winding direction or the direction of rotation of a receiving space course on the carrier body side remains constant inside and outside the basic shape pairs 42, 42′.

After and/or during the receiving of the conductor body 2 in or on a receiving region 6 of the carrier body 7 provided with the conductor body 2, the group formed from conductor body 2 and carrier body 7 can be received at least in portions, in particular completely, in or on a receiving volume 15 of a base body 16, wherein the conductor body 2 and the carrier body 7 and the base body 16 are connected to one another at least in portions in an integrally bonded and/or interlocking fashion during the encapsulation, in particular by means of the injection-molding material 3. The base body 16 can, for example, have a pot-like shape or a pot shape, so that an inner receiving volume 15 is surrounded or defined by a circumferential wall extending circumferentially on the base body side, in particular in the manner of a closed ring. It is possible that the base body 16, in particular having a pot-like shape, has a recess 37. A collar portion 34, for example, may extend at this recess 37. The collar portion 34 may, for example, have a cylindrical shape and form, in the manner of a cylindrical wall, a channel 35 extending at the recess 37 over the main volume of extent 36 of the base body 16. In other words, the channel 35 traverses the base body 16, wherein the collar portion 34, in particular on the base body side, delimits the channel 35 from the receiving volume 15 of the base body 16 in a manner impervious to injection-molding material, in particular in the injection state. It can be provided here that the collar portion 34 prevents, at least in portions, in particular completely, that during the injection of injection-molding material 3 into or onto the receiving volume 15 of the base body 16, injection-molding material 3 can enter or penetrate the channel 35.

It may prove advantageous if the channel 35 runs substantially coaxially with an axis of a conductor body 2 and/or carrier body 7, in particular a spiral conductor body, received in the receiving volume 15 of the base body 16.

In an advantageous embodiment, it may be provided that (a) in or on the carrier body 7 and/or (b) in or on the receiving volume 15 of the base body 16, at least one contact means 17 is arranged before or during the encapsulation and forms an electrically conductive connection to the conductor body 2. In this case, for example, at least one contact means region 18 of the contact means 17 may be exposed after encapsulation and/or at least one contact means region 18 of the at least one contact means 17 projects out of the main volume of extent of the component 1 after the encapsulation; cf. FIG. 2. The contact means region 18 projecting out of the main volume of extent 36 of the base body 15 may, for example, serve as an interface or as a plug contact for a corresponding plug/socket counterpart (not shown).

It can optionally be provided that (a) in or on the carrier body 7 and/or (b) in or on the receiving volume 15 of the base body 16 at least one iron core (not shown) and/or electrical component (not shown) and/or magnetic-field-conducting element (not shown) is arranged before or during the encapsulation and is encapsulated with or by the injection-molding material 3 at least in portions during the encapsulation. This makes it possible to connect further elements of the component 1 to the carrier body 7 and/or the base body 16, in particular non-detachably, in the course of the encapsulation.

A conductor body 2 can, for example, be designed as a stranded wire body 19 and can have at least one group of electrically conductive individual wires 38; cf. FIG. 13. Preferably, the stranded wire body 19 has at least in portions, in particular completely, at least one group of electrically conductive individual wires 38, which is/are designed as high-frequency stranded wires and/or high-voltage stranded wires and/or as individual wires 38 insulated from one another or with respect to one another by an insulating layer 39, in particular by an insulating layer 39 designed as a lacquer layer. The group of individual wires 38, for example each provided with an insulating layer 39, can optionally be insulated from the environment 41 via at least one insulating means 40. The environment 41 is thus intended to mean the area directly adjacent to the insulating means 40, which can be, for example, an injection-molded body 4 or a carrier body 7. An insulating means 40 can also be used for a conductor body 2 comprising a solid wire.

In an advantageous embodiment, it can be achieved with the use of the carrier body 7 that an insulating means 40 of the conductor body 2, in particular of the stranded wire body 19, and/or an insulating layer 39 of a stranded wire body 19 has to fulfil a lower requirement with regard to its electrical effectiveness or its electrical insulating effect, since the actual electrical insulating function can be performed at least in part by the carrier body 7 and/or by the injection-molded body 4. In a further embodiment, an insulating means 40 of the conductor body 2 can be dispensed with at least in portions, in particular completely. For example, the insulating material 40 can be dispensed with at least in portions, in particular completely, along the longitudinal axis or along the course of the conductor body 2 and/or the individual wires 38.

The carrier body 7 and/or the base body 16 can be produced at least in portions, in particular completely, from an injection-molding method and/or from an additive manufacturing method. For this purpose, for example, the carrier body 7 and/or the base body 16 can be formed at least in portions, in particular completely, from a plastics material, preferably from a thermoplastic. Particularly preferably, the plastics material is selected in such a way that it can be processed in an injection-molding method, so that, for example, the carrier body 7 and/or the base body 16 can be produced in the course of a plastics injection-molding method.

The carrier body 7 may, for example, comprise at least two carrier sub-bodies, wherein the carrier sub-bodies are assembled before and/or during the receiving of the conductor body 2 in or on the receiving region 6 of the carrier body 7 (not shown). In other words, the carrier sub-bodies may initially be present as separate elements, in particular elements produced separately from one another, and may be joined to one another in a frictionally engaged and/or interlocking and/or integrally bonded fashion before or during the receiving of the conductor body. For example, assembly or connection of the carrier sub-bodies takes place by means of a clip connection (i.e. snap-lock connection), wherein the portions forming the clip connection can be formed, in particular in one piece, on the carrier sub-bodies. By means of a carrier body 7 comprising several separate parts or carrier sub-bodies, the production of the carrier sub-body 7 can be simplified and/or the possibilities of the constructive geometric design of the carrier element 7 can be extended.

A carrier body 7 can, for example, comprise at least two carrier sub-bodies, wherein at least two carrier sub-bodies each comprise a receiving sub-region for forming the receiving region 6 at least in portions. Here, optionally, at least in the state of the encapsulated component 1, the at least one conductor body 2 can be received in the at least two receiving sub-regions. The term “receiving sub-regions” is to be understood to mean longitudinal portions along the course of the carrier body 7.

For example, a carrier body 7 of which the receiving region 6 has an L-shaped and/or a U-shaped and/or a V-shaped and/or a C-shaped and/or a W-shaped cross-sectional geometry at least in portions can be used. In particular, the carrier body 7 has a constant cross-sectional geometry at least in portions, preferably largely, particularly preferably completely. The embodiment shown in FIG. 6 has a largely constant cross-sectional geometry of the carrier body 7, according to which only the innermost turn or the innermost carrier sub-portion has a flatter shape than the other carrier sub-portions arranged further outward.

For example, a receiving region 6 of the carrier body 7 may have a first axial length 24 in a first receiving region portion 23 and a second axial length 24′, different from the first axial length 24, in a further receiving region portion 23′. Preferably, a first receiving region portion 23 located closer to the center 25 of the component 1 and/or the carrier body 7 has a greater axial length 24 than a further receiving region portion 23′, which is located further away from the center 25 of the component 1 and/or from the center 25 of the carrier body 7 and which has an axial length 24′; cf. FIG. 6. An advantage can be found here in the fact that if the inner diameter of a component 1 designed as an electric coil is predefined, a flattening of the innermost and/or outermost carrier body portion or receiving region portion 23, 23′ can represent an effective and simple means of reducing the radial annular length 20 of the carrier body 7 in the deformed state.

For example, a carrier body 7 can be used which comprises at least in portions, in particular completely, a guide device 28 on a surface 26 of at least one wall portion 27 facing away from the receiving region 6, wherein the guide device 28 carries out a targeted guidance of injection-molding material 3 fed to the carrier body 7 during the encapsulation. Here, for example, the guide device 28 can have a protrusion with a defined geometric shape which cooperates with a corresponding recess of an opposite wall portion 27, 27′ in order to achieve a defined end position of the wall portions 27, 27′; cf. FIG. 11. Preferably, at least one guide device 28 on the carrier body side is adapted to the geometric shape of a base body 16 and/or the position and/or orientation of at least one injection opening of an injection mold for encapsulation of the conductor and carrier body 2, 7 received therein, in order to achieve a defined encapsulation of the conductor and carrier body 2.

The guide device 28, in particular on the carrier body side, can for example alternatively or additionally have a spacing function, by means of which at least two wall portions 27, 27′ of the carrier body 7 are held at a defined spacing 21 at least in the deformed state of the carrier body 7. Alternatively or additionally, a separate element, for example a spacing device, of the carrier body 7, in particular of the wall portion 27, 27′, can be provided to achieve such a spacing 21.

The gap formed by the spacing 21 can be used to guide and/or place the injection-molding material 3 during the encapsulation process. Consequently, the guide device 28, 28′ or the spacing device can ensure a gap during the encapsulation in order to be able to carry out the encapsulation process in a more defined and/or quicker way; cf. FIG. 10.

At least one conductor body 2 received in the receiving region 6 of the carrier body 7, at least in the state before the carrier body 7 provided with the conductor body 2 is encapsulated with the injection-molding material 3, can, for example, be held in or on the receiving region 6 by means of a holding means 29, in particular on the carrier body side, in an interlocking and/or integrally bonded and/or frictionally engaged fashion. In the embodiment according to FIG. 6, the holding means 29 is formed as a one-piece or single-material component of the material forming the carrier body 7. The holding means 29 can be designed, for example, as a latching means and/or as a holding means 29 projecting into and/or adjoining the receiving space 5 of the receiving region 6 of the carrier body 7. In particular in the state of the inserted conductor body 2, the holding means 29 can, for example, contact the conductor body 2 or apply a clamping and/or pretensioning force thereto. Thus, the conductor body 2 can be fixed or held in a defined region of the carrier body 7. Consequently, during the encapsulation and/or during a displacement of the assembly consisting of conductor body 2 and carrier body 7 into an injection mold, an undesired relative movement of the bodies 2, 7 can be prevented by the holding means 29. The holding means 29 can also hold the conductor body 2 received in the receiving region 6 of the carrier body 7 during the deformation or bending of the carrier body 7 and the deformation or bending of the conductor body 2 in the receiving region 6 of the carrier body 7 or can prevent the conductor body 2 from moving out.

During the receiving of the conductor body 2 in or on the receiving region 6 of the carrier body 7 by means of a guide means 32, in particular on the carrier body side (see FIG. 6), for example, the conductor body 2 can be guided at least in portions, in particular completely, into the receiving region 6. In other words, for example, guide means 32 on the carrier body side can be guided at least during part of the feed path of the conductor body 2 into the receiving region 6 of the carrier body 7 or can be selectively influenced in respect of their movement path. It is possible, at least in portions, to form the holding means 29 and the guide means 32 in one piece or as one element which fulfils both functions.

During the modification of the geometric shape of the conductor body 2 and/or of the carrier body 7, for example (a) an at least partial, in particular complete, guidance of a relative movement 30, 30′ of at least two carrier body sub-regions 31, 31′ by means of a guide portion (not shown), in particular on the carrier body side, and/or (b) an interlocking and/or a frictionally engaged and/or integrally bonded connection of at least two connection portions 33, 33′, in particular on the carrier body side, can take place. The guide portions, for example on the carrier body side, and/or the connection portions 33, 33′, for example on the carrier body side, can perform guiding and/or connecting or holding functions in conjunction with the selective deformation or the change in shape and the fixing, at least in portions, of the change in shape by means of the carrier body 7 itself. A guide portion can, for example, additionally fulfil the function of a spacing device at least in portions, so that a spacing 21 can be produced on account of the guide portion.

If the carrier body is produced using an injection-molding method (for example plastics injection-molding method) or an additive manufacturing method (for example CLIP, SLA, etc.), the guiding and/or connecting or holding function can be implemented in a simple and cost-effective way. FIGS. 6 and 12 show two connection portions 33, 33′ hooked into one another, which hook into one another, for example, during a compression of the carrier body sub-regions 31, 31′ and consequently form an interlocking and/or frictionally engaged connection. In this case, a first carrier body sub-region 31 may be provided with a first connection portion 33 and a second carrier body sub-region 31′ may be provided with a second connection portion 33′, wherein in the compressed state the interconnected connection portions 33, 33′ prevent the compressed state from springing back or decompressing.

For example, a first conductor body 2 can be received in a receiving region 6 delimiting a first receiving space 5 and a further conductor body 2 can be received in a receiving region 6 delimiting a further receiving space 5 (not shown). Further, before at least one carrier body 7 provided with the conductor body 2 is encapsulated with an injection-molding material 3, at least two conductor bodies 2 can optionally be received in different receiving spaces 5 (not shown). This can result in a component 1 in which different conductor bodies 2 are arranged at different locations. The electrically and/or magnetically effective functionality of the component 1 can be extended by appropriately actuating or energizing the different conductor bodies 2 via contact means 17 assigned to the respective conductor bodies 2.

The invention also relates to a component 1, in particular a component designed as an electric coil; cf. FIGS. 2 and 3. This component 1, in particular designed as an electric coil, can be installed in a vehicle, preferably in a motor vehicle. Alternatively or additionally, the component can be used as part of a sensor system and/or an actuator system, in particular in vehicle construction.

Lastly, the invention comprises a device for producing a component 1 comprising a conductor body 2 and a carrier body 7 according to a method described herein.

FIG. 12 shows the transition of the receiving region 5 from a first to a second axial plane. In this context, an axial plane is a plane running perpendicular to the axis 10 of the spiral shape 9 of the conductor body 2 and/or the carrier body 7, in particular perpendicular to the coil axis. In other words, the at least two axial planes are axially offset from each other. This transition region 22 can be understood as a discontinuity in the spiral shape 9, since in this region there may be deviations from the rest of the shape and/or arrangement of the conductor body 2 and/or the carrier body 7. It is also apparent from FIG. 12 that a first connection portion 33 extends from the first axial plane (which is at the bottom in the drawing) into the second axial plane and engages there with the second connection means 33′, which is formed by a part of the carrier body 7 lying in the second axial plane, and in particular prevents the carrier body 7 from springing back into an undeformed state; cf. FIG. 4.

### LIST OF REFERENCE SIGNS

1 component
2 conductor body
3 injection-molding material
4 injection-molded body
5 receiving space
6 receiving region
7 carrier body
8 body volume of 2 and 7
9 spiral shape of 2 and/or 7
10 axis of 9
11 first basic shape of 2 and/or 7
12 further basic shape of 2 and/or 7
13 tapered region of 11
14 tapered region of 12
15 receiving volume of 16
16 base body
17 contact means
18 contact means region of 17
19 stranded wire body
20 annular length of 7
21 spacing of 27, 27′
22 transition region
23, 23′ receiving region portion (cross-sectional portion)
24, 24′ axial length of 23, 23′
25 center of 1
26 surface of 27
27, 27′ wall portion of 7
28 guide device
29 holding means
30′ relative movement
31, 31′ carrier body sub-region/carrier sub-body
32 guide means
33, 33′ connection portions
34 collar portion
35 channel
36 main volume of extent of 16
37 recess of 16
38 individual wire
39 insulating layer
40 insulating means
41 environment
42, 42′ basic shape pair

1. A method for producing a component provided with at least one electrically conductive conductor body, wherein the conductor body is surrounded at least in portions, in particular largely, in an integrally bonded and/or interlocking fashion by an injection-molded body formed from an injection-molding material, the method comprising:
receiving the conductor body at least in portions in or on a receiving region of a carrier body, which receiving region delimits a receiving space,
encapsulating the carrier body, provided with the conductor body, at least in portions with the injection-molding material to form a component comprising at least the conductor body, the carrier body and the injection-molded body.

2. The method according to claim 1, wherein after and/or during the receiving of the conductor body in or on the carrier body, the geometric shape of the carrier body is modified at least in portions, wherein with the modification of the geometric shape of the carrier body the conductor body undergoes, at least in portions, a change in shape that is similar or identical, in particular in comparison with the deformation of the carrier body.

3. The method according to claim 2, wherein the change in shape of the conductor body and/or the carrier body after arranging the conductor body in or on the receiving region of the carrier body comprises a deformation such that a body volume formed by the conductor body and/or the carrier body becomes more compact.

4. The method according to claim 2, wherein at least one portion of the conductor body and/or of the carrier body undergoes a linear and/or a rotational movement during its deformation, in particular the conductor body and/or the carrier body is bent during the deformation.

5. The method according to claim 1, wherein the conductor body and/or the carrier body, in particular during or already prior to its deformation, at least in portions has at least a spiral shape, preferably a spiral shape comprising at least a basic cone-like shape and/or a basic cylinder-like shape and/or a basic pyramid-like shape, and particularly preferably the spiral shape is compressed along an axis of the spiral shape during the deformation of the conductor body and/or the carrier body.

6. The method according to claim 1, wherein a first portion of the conductor body and/or carrier body has a first, spiral, in particular cone-like or pyramid-like, basic shape and a second portion of the conductor body and/or carrier body has a second, spiral, in particular cone-like or pyramid-like, basic shape, wherein a tapering region of the first spiral basic shape faces towards or faces away from a tapering region of the second spiral basic shape.

7. The method according to claim 1, wherein, after or during the receiving of the conductor body in or on a receiving region of the carrier body, in a first injection-molding process, a first injection-molded body is molded onto or overmolded on the conductor body and/or the carrier body at least in portions, in particular completely, and in a second injection-molding process carried out in time after the first injection-molding process, a second injection-molded body is molded onto or overmolded on the first injection-molded body and/or the conductor body and/or the carrier body at least in portions.

8. The method according to claim 1, wherein after or during the receiving of the conductor body in or on a receiving region of the carrier body, the carrier body provided with the conductor body is received at least in portions, in particular completely, in or on a receiving volume of a base body, wherein, during the encapsulation, in particular by means of the injection-molding material, the conductor body, the carrier body and the base body are connected to one another at least in portions in an integrally bonded and/or interlocking fashion.

9. The method according to claim 1, wherein:
in or on the carrier body and/or
in or on the receiving volume of the base body,
at least one contact means is arranged before or during the encapsulation and forms an electrically conductive connection to the conductor body, preferably at least one contact means region of the contact means is exposed after the encapsulation and/or at least one contact means region of the at least one contact means projects out of the main volume of extent of the component after the encapsulation.

10. The method according to claim 1, wherein:
in or on the carrier body and/or
in or on the receiving volume of the base bod,
before or during the encapsulation there is arranged at least one iron core and/or electrical component and/or magnetic-field-conducting element, which during the encapsulation is encapsulated with the injection-molding material at least in portions.

11. The method according to claim 1, wherein a conductor body is used which is designed as a stranded wire body and is formed at least from a group of electrically conductive individual wires preferably the stranded wire body has at least in portions, in particular completely, at least one group of electrically conductive individual wires which are designed as high-frequency stranded wires and/or high-voltage stranded wires and/or as individual wires insulated from one another by an insulating layer, in particular by means of an insulating layer designed as a lacquer layer.

12. The method according to claim 1, wherein that the carrier body and/or the base body is produced at least in portions, in particular completely, from an injection-molding method and/or from an additive manufacturing method.

13. The method according to claim 1, wherein the carrier body and/or the base body is formed at least in portions, in particular completely, from a plastics material, preferably from a thermoplastic.

14. The method according to claim 1, wherein the carrier body comprises at least two carrier sub-bodies, wherein the carrier sub-bodies are assembled before and/or during the receiving of the conductor body in or on the receiving region of the carrier body.

15. The method according to claim 1, wherein a carrier body is used which comprises at least two carrier sub-bodies, wherein at least two carrier sub-bodies in each case comprise a receiving sub-region for forming the receiving region at least in portions, wherein the at least one conductor body, in particular at least in the state of the encapsulated component, is received in the at least two receiving sub-regions.

16. The method according to claim 1, wherein a carrier body is used, the receiving region of which has, at least in portions, an L-shaped and/or a U-shaped and/or a V-shaped and/or a C-shaped and/or a W-shaped cross-sectional geometry, and in particular the carrier body has, at least largely, a constant cross-sectional geometry.

17. The method according to claim 1, wherein a carrier body is used, the receiving region of which has a first axial length in a first receiving region portion and a second axial length, different from the first axial length, in a further receiving region portion, preferably a first receiving region portion located closer to the center of the component has a greater axial length than a further receiving region portion located further away from the center of the component.

18. The method according to claim 1, wherein a carrier body is used, which comprises a guide device at least in portions on a surface of at least one wall portion facing away from the receiving region, wherein the guide device carries out a selective guidance of injection-molding material fed to the carrier body during the encapsulation, preferably at least one guide device on the carrier body side is adapted to the geometric shape of a base body and/or the position and/or orientation of at least one injection opening of an injection mold for encapsulating the conductor and carrier body received therein, in order to achieve a defined encapsulation of the conductor and carrier body.

19. The method according to claim 1, wherein at least one conductor body received in the receiving region of the carrier body, at least in the state before the carrier body provided with the conductor body is encapsulated with the injection-molding material, is held in or on the receiving region by means of a holding means, in particular on the carrier body side, in an interlocking and/or integrally bonded and/or frictionally engaged fashion.

20. The method according to claim 1, wherein while the conductor body is being received in or on the receiving region of the carrier body, the conductor body is guided at least in portions, in particular completely, into the receiving region by means of a guide means, in particular on the carrier body side.

21. The method according to claim 2, wherein during the modification of the geometric shape of the conductor body and/or the carrier body,
an at least partial, in particular complete, guidance of a relative movement of at least two carrier body sub-regions by means of a guide portion, in particular on the carrier body side, and/or
an interlocking and/or a frictionally engaged and/or integrally bonded connection of at least two connection portions, in particular on the carrier body side takes place.

22. The method according to claim 1, wherein a first conductor body is received in a receiving region delimiting a first receiving space and a further conductor body is received in a receiving region delimiting a further receiving space, in particular before at least one carrier body provided with the conductor body is encapsulated with an injection-molding material.

23. A component, in particular electric coil, comprising a conductor body and a carrier body, produced in a method according to claim 1.

24. A device for producing a component comprising a conductor body and a carrier body by a method according to claim 1.
